(19) United States
(12) Patent Application Publication
(10) Pub. No.: US 2004/0109686 A1
(43) Pub. Date: Jun. 10, 2004

(54) Architecture for metropolitan dense wavelength division multiplex network with all-optical reference node

(76) Inventor: Chao Xiang Shi, Cupertino, CA (US)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/646,027

(22) Filed: Aug. 22, 2003

Related U.S. Application Data
(60) Provisional application No. 60/405,156, filed on Aug. 22, 2002.

(51) Int. Cl. H04B 10/24

(52) U.S. Cl. 398/41

(57) ABSTRACT

An all-optical reference node in an optical communication network detects the power in each channel and, using an optical power monitor and a series of voltage-controlled attenuators connected in a feedback loop, adjusts the power in each channel so as to equalize the power in all channels. The optical reference node also removes amplified spontaneous emissions. Likewise, the power of each channel added at an add/drop node is equalized to the power in the channels that pass through the add/drop node. Thus the power in the respective channels is equal through the network, and amplifiers located at intervals on the network are not driven into saturation as they attempt to amplify weaker signals. According to another embodiment, a simplified optical communication network contains only passive components.

This application claims the priority of provisional application No. 60/405,156, filed Aug. 22, 2002.

### FIELD OF THE INVENTION

This invention relates to optical communication networks and, in particular, metropolitan area optical communication networks.

### BACKGROUND OF THE INVENTION

Metropolitan optical communication networks typically include an optical fiber “ring” around which a number of optical “add/drop” nodes are positioned. A series of channels, represented by optical wavelengths, circulate around the ring in a particular direction. At each add/drop node, one or more channels (frequencies) are diverted from the ring (i.e., dropped). The remaining channels pass by the add/drop node and continue on to their destination nodes. The dropped channels contain voice or data messages intended for recipients in the local area associated with the node. The same channels (frequencies), containing voice or data messages originating from this local area, are added back to the ring at the add/drop node, and these channels continue around the ring until they reach an add/drop node where they are transmitted to another local area or a “hub” where they are diverted to locations outside the metropolitan area served by the ring.

The signals in the various optical channels are typically amplified by erbium doped fiber amplifiers (EDFAs). One problem arises from the fact that the various channels are inserted at different points around the ring. The input to a given EDFA typically includes channels that have more power, because they were inserted relatively close to the EDFA as well as channels that are weaker, because they were inserted at add/drop nodes more distant from the EDFA. The gain of the EDFA is normally adjusted to amplify the weaker channels, and as a result the stronger channels will cause the EDFA to become saturated. These problems become more pronounced as the length of the ring and number of add/drop nodes are increased.

Moreover, since the ring is in effect a closed feedback loop, the amplified spontaneous emissions (ASE) at frequencies between the channels must be controlled. Otherwise, the ASE will increase to the point where they drown out the channel frequencies, which is referred to as “fiber ring lasing.” FIGS. 3A and 3B illustrate how the ASE circulation can eventually evolve into fiber ring lasing where a frequency λx increases to power levels that are much higher than the channels λ1, λ2, λ3 . . . λn.

The power in the channels must therefore be controlled. This is normally done by means of an optical-electrical-optical 3R regenerator. (This is often referred to as an “O-E-O 3R generator;” “3R′ stands for reshape, re-amplify, and re-time.) In an O-E-O 3R regenerator the signals are converted from optical to electric and then back to optical. O-E-O 3R regenerators tend to be expensive. Furthermore, in multiple wavelength WDM systems, each wavelength must have its own dedicated 1 O-E-O 3 R regenerator. Therefore, the presence of multiple wavelengths increases the overall cost even more. For this reason, it would be desirable to control the power in the various channels with an all-optical device.

### SUMMARY OF THE INVENTION

An optical communications network according to this invention includes an all-optical reference node. The optical reference node contains a demultiplexer-multiplexer that separates all the wavelength channels into parallel optical fibers and then recombines the optical communication channels (frequencies) into a single optical fiber. The optical reference node also removes amplified spontaneous emissions (ASE) at frequencies between the channels. At the output terminal of the multiplexer a fraction of the power is diverted to an optical channel monitor. The optical channel monitor drives a series of voltage-controlled attenuators in the parallel optical fibers so as to set the power in each channel to a desired level. As a result the power in the channels at the output of the optical reference node is the same and at a predetermined level. Thus the optical reference node prevents lasing problems in network by terminating the circulation of amplified spontaneous emissions (ASE) in the fiber ring and generates a reference power for each of channels, thereby allowing the power in the channels to be balanced and equalized.

Preferably, the network contains a series of add/drop nodes where the power of the dropped channel is measured the power of the added channel is adjusted to be equal to the power of the dropped channel. In one embodiment, optical service channels, independent of the main “ring” of the network, are connected between the optical reference node and the first add/drop node and between successive add/drop nodes. The optical service channel detects the power in the channels at the “upstream” node (either the optical reference node or one of the add/drop nodes), measures the span loss between the upstream node and downstream add/drop node and subtracts the span loss from the power at the upstream node to determine the power at the downstream add/drop node. The downstream add/drop node adjusts the power of the added channel to be equal to the power of each of the channels that pass through the node. In an alternative embodiment the downstream node measures the power in the dropped channel directly and sets the power of the added channel to be equal to the power of the dropped channel.

As a result, the power of all channels is equalized throughout the network. With the power in all channels equalized, the amplifiers that are located at intervals on the network do not saturate as they do when they are required to amplify weaker signals input at distant locations on the network along with stronger channels input at closer locations.

In accordance with another aspect of this invention, a simplified optical communications network contains only passive components. Each add/drop module contains optical filters which add and drop a single channel, and a hub contains a mux filter for multiplexing optical transmissions flowing from an external switch to the network and a demux filter for demultiplexing optical transmissions flowing from the network to an external switch. Both the mux filter and the demux filter are passive components. The relatively simple equipment in the all-passive network is very reliable. There is no need for performance monitoring or network management. No fan cooling system is required. The network has a simple “plug and play” operation.

### BRIEF DESCRIPTION OF THE DRAWINGS

FIG. 1 is a schematic diagram of an optical communications network in accordance with this invention.

FIG. 2 is a schematic diagram of the optical reference node.

FIGS. 3A and 3B are graphs of the optical spectrum illustrating the problem of lasing in the network.

FIG. 4 is a schematic diagram of an add/drop node that operates in conjunction with an optical service channel.

FIG. 5 is a schematic diagram of an alternative embodiment of an add/drop node.

FIG. 6 is a schematic diagram of an add/drop node for dropping multiple channels.

FIG. 7 is a schematic diagram of an alternative embodiment of an add/drop node for dropping multiple channels.

FIG. 8 illustrates a prior art metropolitan communication network.

FIG. 9 illustrates a simplified, all-passive optical communication network in accordance with another aspect of this invention.

FIG. 10 shows a schematic diagram of an all-passive add/drop module in the network shown in FIG. 9.

FIG. 11 shows a schematic view of the all-passive hub in the network shown in FIG. 9.

### DESCRIPTION OF THE INVENTION

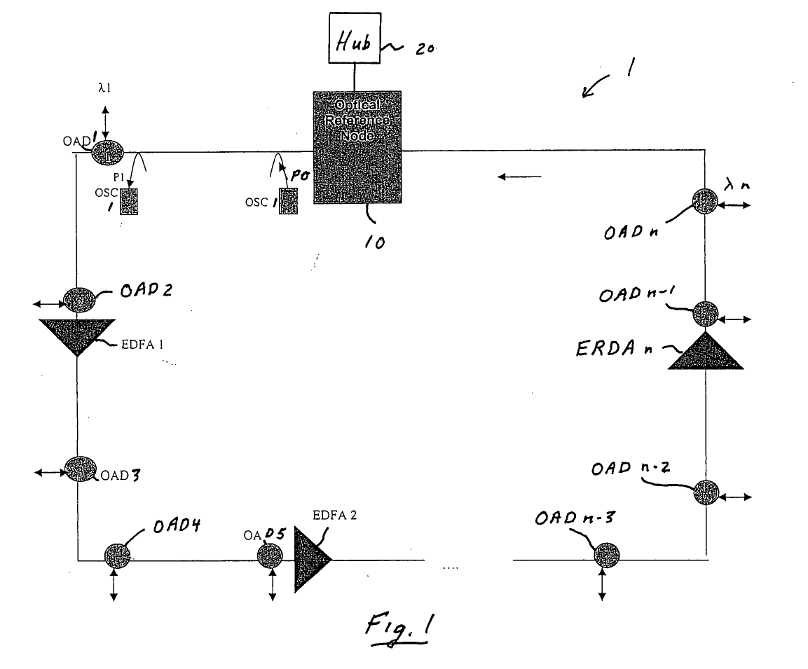

FIG. 1 shows a schematic diagram of a metropolitan optical communication network 1. Network 1 is in the form of a closed ring. The optical add/drop (OAD) nodes in network 1 are designated OAD 1, OAD 2 . . . OAD n-1, OAD n. As indicated by the double arrows at each OAD node, particular channels (frequencies) are diverted or dropped and added back to the network at each OAD node. For example, channel λ1 is added/dropped at OAD 1, and channel λn is added/dropped at OAD n. There may any number n of channels λ, and more than one channel may be added/dropped at a given OAD node. Also shown are erbium doped fiber amplifiers (EDFAs), designated EDFA 1, EDFA 2 . . . EDFA n. As indicated above, the EDFAs are positioned at intervals around network 1 to amplify the optical signals. OADs are standard devices available from Avenx, Oplink, and JDS Uniphase. EDFAs are available from JDS Uniphase, Nortel Networks, and Agere.

Also shown in FIG. 1 is an optical reference node 10 in accordance with this invention. Optical reference node 10 is connected to a hub 20 which is outside network 1 and which, for example, may in turn be connected to a long-distance optical network.

In FIG. 1, for clarity the optical data is shown as flowing only in a counterclockwise direction around the ring of network 1. It will be understood, however, that the ring normally contains two optical fibers, one for clockwise transmissions and the other for counterclockwise transmissions. Suitable amplifiers and OADs are normally provided in each ring.

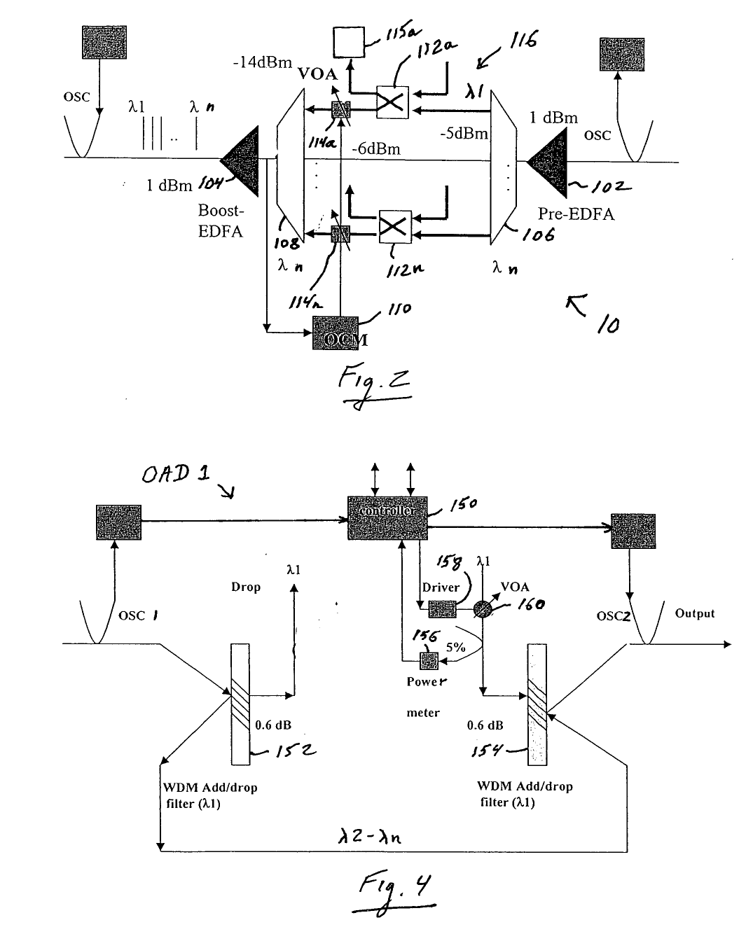

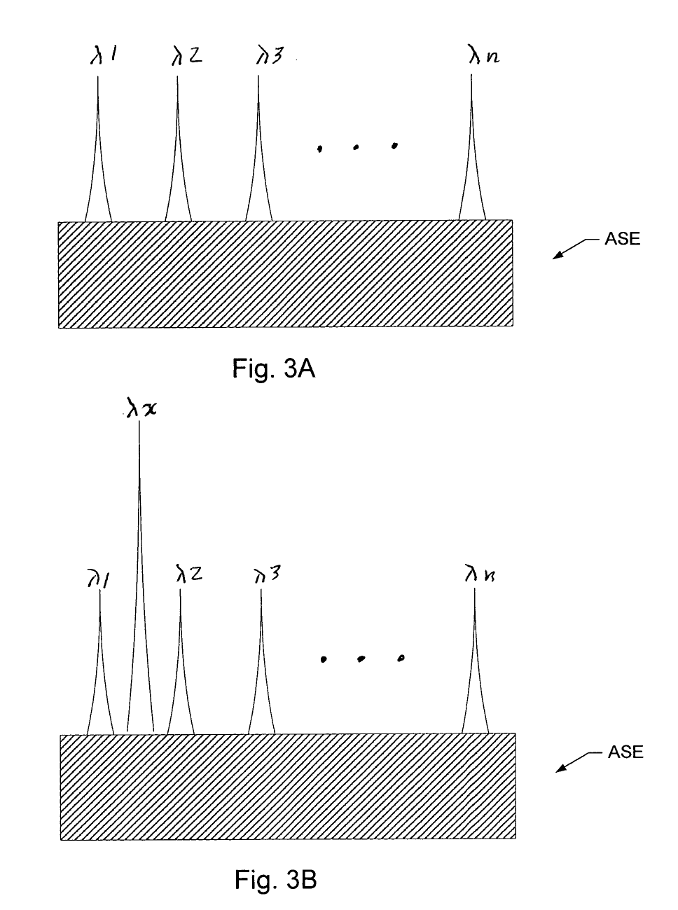

FIG. 2 is a more detailed schematic diagram of optical reference node 10. In optical data is delivered first to a pre-EDFA 102, where it is amplified to a predetermined level, e.g., 1 dBm. At the output of EDFA 102 the signals goes to a multiplexer-demultiplexer 116, which contains a demultiplexer 106 and a multiplexer 108. Demultiplexer 106 filters out the amplified spontaneous emissions (ASE) that are generated by the EDFAs 1 through n and separates the channels λ1-λn so that they are delivered in parallel at the output terminals of demultiplexer 106. The parallel lines from demultiplexer 106 lead, respectively, to the input terminals of multiplexer 108 and contain 2×2 optical switches 112a-112n and voltage-controlled attenuators (VOA) 114a-114n, respectively. One input terminal and one output terminal of each of 2×2 optical switches 112a-112n is connected to external circuitry which leads to hub 20, for example. One output terminal of optical switch 112a is shown as connected to a transponder 115A, for example. Thus, 2×2 optical switches individually can be set either to pass the signals from one of channels λ1-λn through to multiplexer 108 or to divert the signal in that channel to the external circuitry and add a signal from the external circuitry and transmit the added signal to multiplexer 108.

The signals are combined in a single optical fiber at the output of multiplexer. The power in the channels λ1-λn typically has fallen as it passes through multiplexer-demultiplexer 116. For example, as shown in FIG. 2, the signals could have power of 1 dBm at the output of pre-EDFA 102, −5 dBm at the output terminals of demultiplexer 106, and −6 dBm at the output terminals of 2×2 optical switches 112a-112n. Equally important the power in each channel is normally somewhat different. To equalize the power in the channels λ1-λn, at the output of multiplexer 108 a relatively small amount of the power in each channel (e.g., 5%) is diverted into an optical channel monitor (OCM) 110, using, for example, a 10% optical coupler. OCM 110 is connected in a feedback loop that contains VOAs 114a-114n. OCM 110 monitors the power in each channel and sends a signal to each of VOAs 114a-114n to set the power at the input terminals of multiplexer 108 at a desired level. For example, in FIG. 2, the power in each channel at the output terminals of VOAs 114a-114n is set such that the power in that channel at the output terminal of multiplexer 108 is equal −14 dBm.

At the output side of multiplexer-demultiplexer 116 is an optional boost-EDFA 104 which, in the example shown in FIG. 2, has a gain that is sufficient to increase the power in each of the channels λ1-λn to 1 dBm. Thus after leaving optical reference node 10, the power in each of the channels λ1-λn is equal and at a known level.

Thus, optical reference node 10 performs two functions: First, optical reference node 10 prevents possible lasing problems in network 1 by terminating the circulation of ASE in the fiber ring. Second, by resetting the power in each channel to the same level, optical reference node 10 generates a reference power for each of channels λ1-λn, thereby allowing the power in the channels to be balanced and equalized. When network 1 is installed, initially the power in each of the channels arriving at optical reference node 10 is normally different. In passing through optical reference node 10, however, the power in each channel is set to the same level. Accordingly, after optical reference node 10 is functioning, as shown in FIG. 2, the power in each of channels λ1-λn at the output terminal of boost EDFA 104 (+1 dBm) is the same as the power in each of channels λ1-λn at the input terminal of pre-EDFA 102.

Referring again to FIG. 1, an optical service channel (OSC) designated OSC 1 runs between optical reference node 10 and OAD 1. OSC 1 is an optical circuit that is independent of the main “ring” in network 10. In one embodiment, for example, OSC 1 operates at a wavelength of 1510 nm. The power in OSC 1 at a first point in OSC 1 (i.e., at optical reference node 10) is measured using a photodetector, and data indicating the power of the signal in OSC 1 at optical reference node 10 is transmitted to a second point in OSC 1 (i.e., at OAD 1). The power of the signal in OSC 1 at the second point (OAD 1) is measured, again using a photodetector, and then compared with the data which indicates the power in OSC 1 at optical reference node 10. Suitable photodetectors are available from JDS Uniphase. This comparison is made using a microprocessor. The difference between power indicated by the data and the measured power represents the power loss in OSC 1 between the first and second points in OSC 1 (i.e., between optical reference node 10 and OAD 1). This difference is used to determine the “span loss” in network 10 between optical reference node 10 and OAD 1.

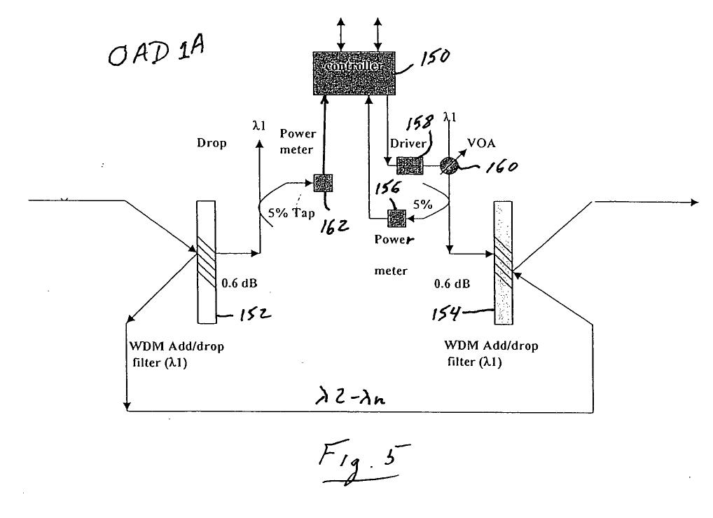

FIG. 4 is a detailed schematic view of OAD 1. The optical signal from optical reference node 10 arrives on the left side, and the signal in channel λ1 is filtered from network 10, as described above, by a wavelength division multiplex (WDM) optical filter 152. Channels λ2-λn are not filtered out by optical filter 152 and proceed through OAD 1 without change.

OSC 1 computes the power in channel λ1 (which, because of the equalization process performed in optical reference node 10, is equal to the power in channels λ2-λn), and transmits this information to a controller 150. Controller 150 could be microprocessor. Controller 150 is connected into a feedback loop that contains a driver 158, a voltage-controlled attenuator (VOA) 160 and a power meter 156. The signal in channel λ1 that is to be added back to network 10 passes through VOA 160. A small fraction (e.g., 5%) of this signal is diverted to a power meter 156, which measures the power in the signal and transmits this information to controller 150. Controller 150 controls driver 158 so that VOA 160 corrects as necessary the power of the signal in channel λ1 that is to be added back to network 10. The signal in channel λ1 is then added back to network 10 by means of a WDM optical filter 154.

In the example shown in FIG. 4, the power in each of channels λ2-λn fell from 1 dBm to 0.6 dBm in the span from optical reference node 10 to OAD 1. Thus the span loss was 0.4 dBm, and the power in each of channels λ1-λn leaving the output terminal of OAD 1 is 0.6 dBm.

An optical service channel OSC 2 runs between OAD 1 and OAD 2. In a manner similar to that described in reference to OSC 1, OSC 2 determines the span loss between OAD 1 and OAD 2, and OAD 2 operates to ensure that the power in all channels λ1-λn is equal at the output terminal of OAD 2. Thus, referring to FIG. 1, the power in each of channels λ1-λn is the same at the input of EDFA 1, and EDFA 1 does not saturate in the manner described above when the power in the channels is different. Optical service channels are likewise connected between the respective pairs of OAD 2, OAD 3 . . . OAD n, thereby ensuring that the power of the signals in channels λ1-λn is the same at the output terminals of each optical add/drop node.

FIG. 5 shows an alternative embodiment of the optical add/drop node. In OAD 1A, the optical service channel is omitted. Instead, a small fraction of the optical power in channel λ1 is diverted to a power meter 162. Power meter 162 measures the power of the signal in channel λ1, and transmits this information to controller 150. Controller 150, in conjunction with driver 158, VOA 160 and power meter 156, controls the power of the signal in channel λ1 that is to be added to network 10 in such a way that the power of the signal in channel λ1 that is to be added to network 10 is equal to the power of the signal in channel λ1 that is dropped from network 10. Each of the optical add/drop nodes 2, 3, . . . n contains a similar arrangement to ensure that the power of the signal in the channel to be added back to network 10 is equal to the power of the signal in the channels that pass through the optical add/drop node

In the optical add/drop nodes OAD 1 and OAD 1A, shown in FIGS. 4 and 5, a single channel (λ1) was dropped from and added to network 10. In situations where two or more channels are to be dropped and added, a number of OADs can be cascaded in series. However, if a large number of channels need to be dropped (e.g., more than eight), cascading a number of OADs may provide an excessive accumulated insertion loss and require too much space. One possible solution is to use a demultiplexer-multiplexer arrangement similar to that of optical reference node 10 to separate out the channels that are to be dropped and added back in. In other situations, an arrangement in the form of OAD 1B, shown in FIG. 6, may be preferable.

In OAD 1B, a number of fiber Bragg gratings (FBGs) 164a, 164b . . . 164m are connected in series in the incoming line of network 10. Each fiber Bragg grating filters out a single one of channels λ1, λ2 . . . λm. The number of channels to be dropped is flexible. A fraction (e.g., 5%) of the power of the last one of the channels (λm in FIG. 6) is diverted with a tape coupler and measured in power meter 162. The measured value of the power in the single channel (Pch) is sent to controller 150. The channels λ1, λ2 . . . λm that are to be added back are fed through a Star-coupler 166 and then the combined signals are sent through VOA 160 and added back to the ring of network 1 using a 90:10 fiber coupler 168. Alternatively, a wavelength division multiplexer (WDM) or CWDM can be used in place of a star-coupler, or a 20:80 or 30:70 fiber coupler could be used. To compensate for the insertion loss of the fiber coupler or WDM, an EDFA 170 is connected in the circuit before the VOA 160. Controller 150 is connected in a feedback loop that contains driver 158, VOA 160 and power meter 156. Reading the power indicated by power meter 162, controller 150 adjusts VOA to ensure that the total power (Ptotal) in the channels λ1, λ2 . . . λm that are to be added to network 10 is equal to Pch+10 log(m), where Pch is the power measured by power meter 162 and m is the number of added channels.

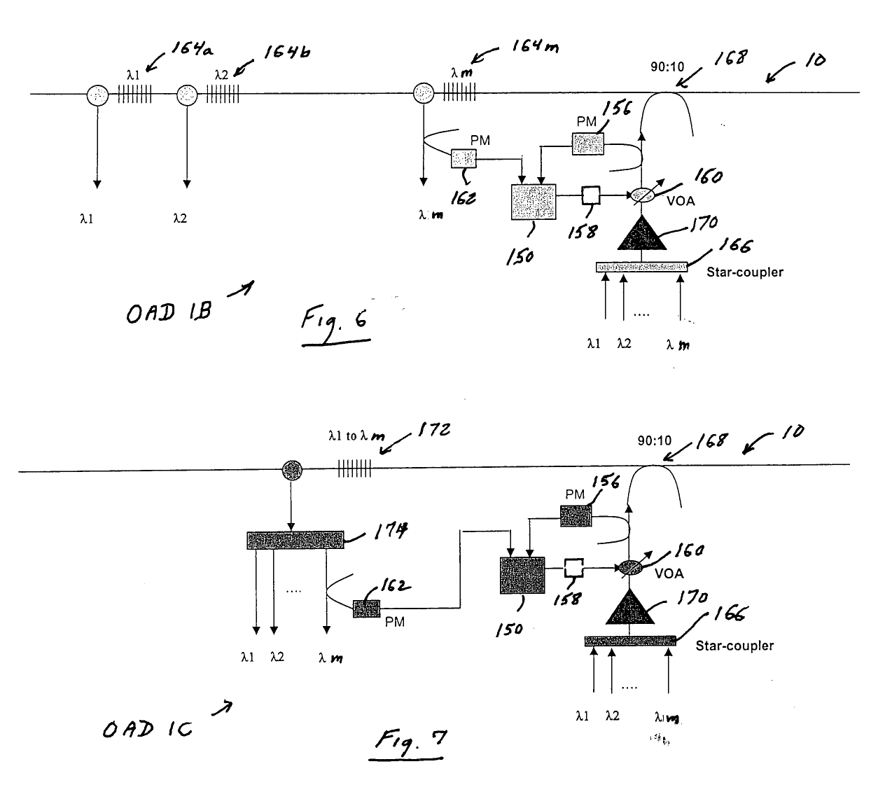

Another flexible add-drop node is shown in FIG. 7. In OAD 1C, a band filter FBG 172 is used to drop channels λ1 -λm, and the signals in the dropped channels are routed through a WDM 174. As in OAD 1B, the power in channel λm is measured in power meter 162. The rest of OAD 1C is identical to and operates in the same manner as OAD 1B.

The embodiments described thus far can be used advantageously with relatively large metropolitan networks. For smaller networks, e.g., networks where the length (circumference) of the ring is 80 km or less, a simplified, an all-passive system may be preferable.

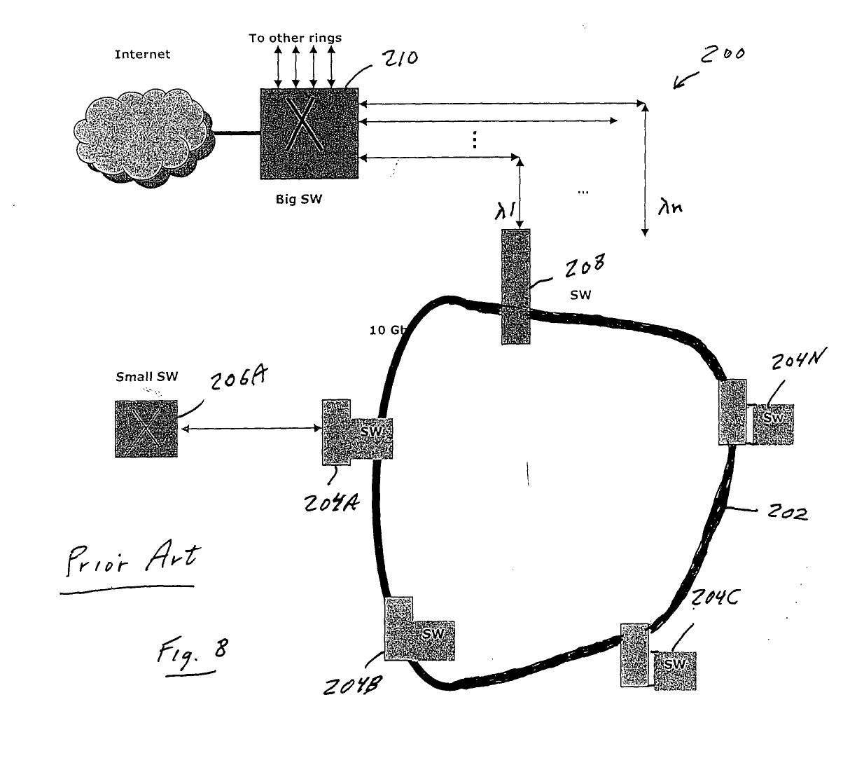

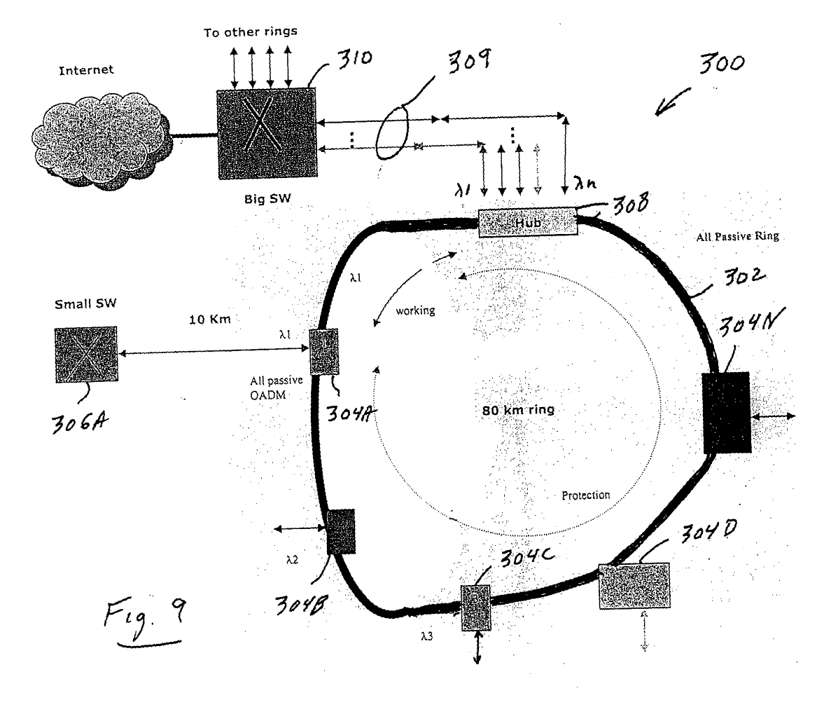

As background, FIG. 8 illustrates a prior art metropolitan communication network 200. The ring 202 includes a plurality of switches 204A, 204B . . . 204N, which are relatively complex, expansive optical-electronic-optical (OEO) switches. Each of switches 204A-204N is typically connected to a small switch which interfaces with a user, exemplified by small switch 206A connected to switch 204A. A single channel (wavelength) may be dropped from ring 202 by switch 204A and transmitted to switch 206A, and the same channel is sent from switch 206A to switch 204A and added back to ring 202. Switches 204A can be Ethernet switches, for example, which sometimes suffer from reliability problems. Also connected in the ring 202 is a switch 208 which demultiplexes the channels and transmits the channels via separate optical fibers to a big switch 210, from which the channels may be routed to other rings (not shown) or to the internet. Switch 208 also receives the channels from separated optical fiber, multiplexes the channels and transmits the channels to ring 202. As indicated, this arrangement is quite expensive and includes a number of active components such as computers, amplifiers, power supplies, etc.

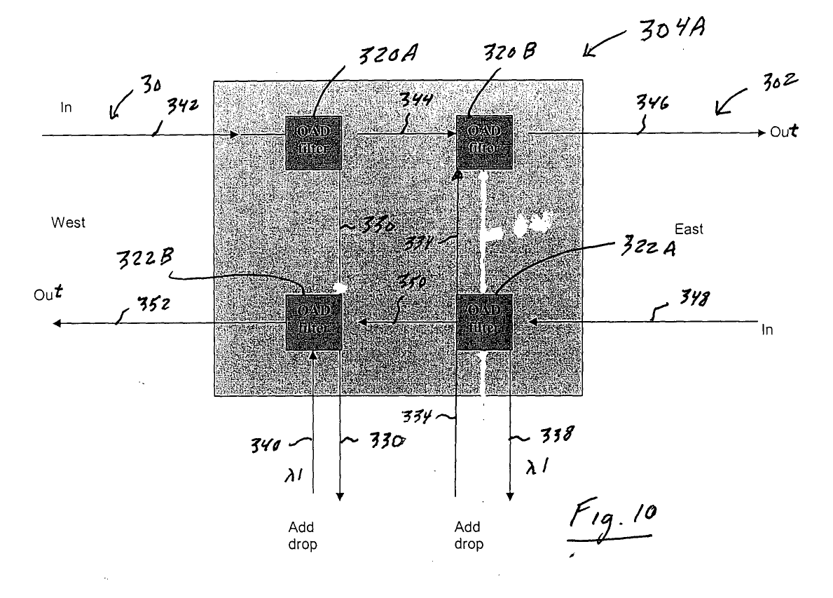

FIG. 9 illustrates a simplified, all-passive optical communication network 300 in accordance with this invention. A ring 302, which is an 80 km ring, includes all-passive optical add/drop modules (OADMs) 304A, 304B, . . . 304N. At each of OADMs 304A-304N a single channel is added and dropped. For example, λ1 is added/dropped at OAD 304A, λ2 is added/dropped at OAD 304b, and so forth. Each of OADMs 304A-304N is linked to a small switch. For example, OADM 304A is connected via a 10 km link to a small switch 306A. Small switch 306A receives the dropped channel λ1 from OADM 304A and transmits channel λ1 to a user network; similarly, small switch 306A receives channel λ1 from the user network and transmits added channel λ1 to OADM 304A.

Also included in ring 302 is a hub 308, which is connected by a number of optical fibers 309 to a large switch 310. Switch 310 connects to other rings (not shown) or to the internet. Hub 308 demultiplexes transmissions from ring 302 and sends them to switch 310 over optical fibers 309 and multiplexes transmissions from switch 310 and transmits them onto ring 302. There is a separate optical fiber for carrying each channel in each direction, i.e., the total number of fibers equals two times the number of channels.

Optical transmissions can flow through ring 302 in either direction, i.e., there are two separate optical fibers in ring 302, one for carrying transmissions in each direction. Typically, when ring 302 is “working,” the transmissions flow in the shortest path among OADMs 304A-304N and hub 308. If ring 302 is broken, however, it may operate in a “protection” mode, in which the transmissions flow in a path which avoids the break in ring 302.

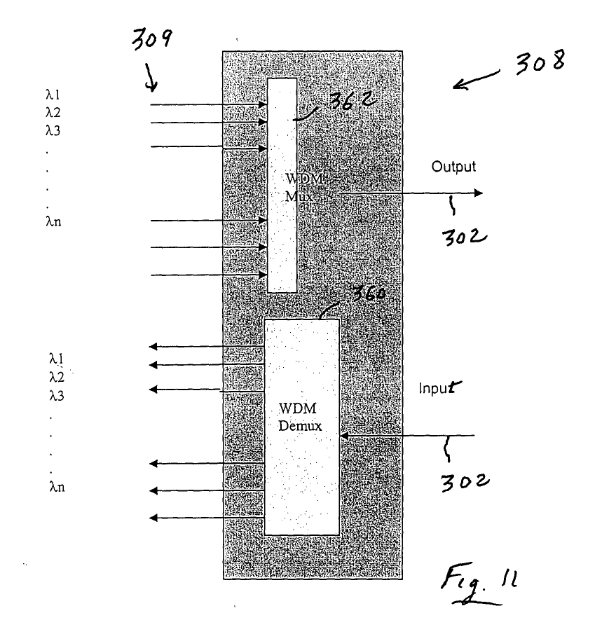

FIG. 10 shows a schematic diagram of OADM 304A, with optical transmissions flowing through the OADM in both directions, i.e., from “west” to “east” in one fiber in ring 302 and from “east” to “west” in the other fiber in ring 302. In this embodiment, only one channel (λ1) is added and dropped at OADM 304A. OADM 304A contains OAD filters 320A, 320B, 322A and 322B, which are passive optical filters available from, for example, JDS Uniphase, Avanex, Oplink, O-net and Koncent. Filters 320A and 322A are drop filters; filters 320B and 322B are add filters. Optical transmissions flowing from west to east on fiber 342 are filtered by OAD drop filter 320A such that channel λ1 is removed from ring 302 and sent to a local area via fiber 330. The dropped channel λ1 arrives at OADM 304A on fiber 334and is transmitted to OAD add filter 320B, where it is added back and transmitted with the other channels (λ2-λn) over fiber 346. The remaining channels (λ2-λn) are not affected by OADM 304A and pass through OAD filters 320A and 320B and fibers 344 and 346 unchanged.

Similarly, optical transmissions flowing from east to west on fiber 348 are filtered by OAD drop filter 322A such that channel λ1 is removed from ring 302 and sent to a local area via fiber 338. The dropped channel λ1 is transmitted over fiber 340 to OAD add filter 322B, where it is added back and transmitted over fiber 352. The remaining channels (λ2-λn) are not affected by OADM 304A and pass through OAD filters 322A and 322B and fibers 350 and 352 unchanged.

OADMs 304B-304N have structures similar to that of OADM 304A, except each of OADMs 304B-304N contains OAD filters that add and drop one of channels λ2-λn.

FIG. 11 shows a schematic view of hub 308, which contains a WDM mux filter 362 and a WDM demux filter 360. Optical transmissions arriving at hub 308 over ring 302 are demultiplexed by WDM demux filter 360 and sent to large switch 310 via fibers 309, with one fiber of each of channels λ1-λn. Conversely, optical transmission arriving at hub 308 via fibers 309 are multiplexed by WDM mux filter 362 and sent onto ring 302. Thus hub 308 is not a conduit for optical transmissions flowing around ring 302, i.e., optical transmissions at the input terminal of hub 308 are sent to large switch 310; they do not continue on ring 302.

WDM mux/demux filters 360 and 362 are passive components and are available from JDS Uniphase, Avanex, Oplink, O-net and Koncent.

The relatively simple, all-passive equipment in network 300 is very reliable. There is no need for performance monitoring or network management. No fan cooling system is required. The network has a simple “plug and play” operation. In contrast, a conventional system of the kind shown in FIG. 8 requires operational costs for a power supply system, a temperature control system, a performance monitoring and alarm system, and a network management system.

While several embodiments according to this invention have been disclosed, it will be understood that these embodiments are illustrative only, and not exhaustive. Many other embodiments within the broad principles of this invention will be apparent to those skilled in the art.

I claim:

1. An optical communication network comprising an optical communication ring, an optical reference node connected in said ring, said optical reference node comprising:
an input terminal of said optical reference node coupled to an input terminal of an optical demultiplexer, said demultiplexer having a plurality of output terminals;
an optical multiplexer having an output terminal and a plurality of input terminals, said output terminal of said multiplexer being coupled to an output terminal of said optical reference node, said input terminals of said multiplexer being coupled to corresponding output terminals of said demultiplexer via a series of parallel optical lines;
a plurality of optical switches connected, respectively, in said series of parallel optical lines;
a plurality of voltage-controlled optical attenuators connected, respectively in said series of parallel optical lines; and
an optical channel monitor, an input terminal of said optical channel monitor being coupled to said output terminal of said multiplexer, an output terminal of said optical channel monitor being coupled to said voltage-controlled optical attenuators.

2. The optical reference node of claim 1 further comprising an optical pre-amplifier connected between said input terminal of said optical reference node and said input terminal of said demultiplexer.

3. The optical reference node of claim 1 further comprising an optical boost amplifier connected between said output terminal of said multiplexer and said output terminal of said optical reference node.

4. The optical reference node of claim 1 wherein each of said optical switches is connected between one of said output terminals of said demultiplexer and one of said voltage-controlled attenuators.

5. The optical reference node of claim 1 wherein each of said switches is a 2×2 switch.

6. An optical communication network comprising an optical communication ring, said ring comprising a plurality of optical add/drop nodes, each of said add/drop nodes comprising:
a controller;
first and second optical add/drop filters, said first add/drop filter being coupled to an input terminal of said add/drop node and being set to pass a predetermined optical channel, said second add/drop filter being coupled to an output terminal of said add/drop node; and
a voltage-controller attenuator and an optical power meter, a control terminal of said voltage-controlled attenuator being coupled to said controller, said optical power meter being connected so as to measure the power of an optical channel emerging from said voltage-controlled attenuator and to deliver a signal representing said power to said controller.

7. The optical communication network of claim 6 further comprising an optical service channel, said optical service channel comprising:
a device for measuring a power at a first point in said optical service channel;
a means for transmitting a data signal in said optical service channel representing said power at said first point;
a device for measuring a power of said optical service channel at a second point in said optical service channel.

8. The optical communication network of claim 7 wherein said means for transmitting comprises a computer.

9. The optical communication network of claim 7 comprising a means for comparing an output of said device for measuring power at said second point with said data signal.

10. The optical communication network of claim 7 wherein said first point is located near an optical reference node and said second point is located near an optical add/drop node.

11. The optical communication network of claim 7 wherein said first point is located near a first optical add/drop node and said second point is located near a second optical add/drop node.

12. The optical communication network of claim 7 wherein said first point is located near an optical add/drop node and said second point is located near an optical reference node.

13. An optical communication network comprising an optical communication ring, said ring comprising a plurality of optical add/drop modules and a hub, each of said add/drop modules comprising:
a first optical filter having an input terminal and a drop terminal, said input terminal of said first optical filter being coupled to an input terminal of said add/drop module; and
a second optical filter having an input terminal coupled to an output terminal of said first optical filter, an output terminal coupled to an output terminal of said add/drop module, and an add terminal; wherein said first optical filter is adapted to filter out a first channel included in an optical transmission at said input terminal of said first optical channel and to deliver said first channel to said drop terminal, and said second optical filter is adapted to add said first channel appearing at said add terminal to an optical transmission appearing at said input terminal of said second optical filter such that said first channel appearing at said add terminal is combined with said optical transmission at said input terminal of said second optical filter;
said hub being connected to said ring, said hub comprising an optical mux filter and an optical demux filter, said demux filter being coupled to an input terminal of said hub, said mux filter being coupled to an output terminal of said hub.

14. The optical communication network of claim 13 wherein said hub further comprises a plurality of terminals each of which is adapted to carry a channel of an optical transmission.
